(19) United States
(12) Patent Application Publication
(10) Pub. No.: US 2023/0241485 A1
(43) Pub. Date: Aug. 3, 2023

(54) Hydrating Mouthguard

(71) Applicant: Todd Peay, Corona, CA (US)

(72) Inventor: Todd Peay, Corona, CA (US)

(21) Appl. No.: 18/013,518

(22) PCT Filed: Jul. 9, 2021
(86) PCT No.: PCT/US2021/041098

§ 371 Date: Dec. 28, 2022

Related U.S. Application Data
(60) Provisional application No. 63/050,547, filed on Jul. 10, 2020.

(51) Int. Cl. A63B 71/08

(52) U.S. Cl. CPC A63B 71/085; A63B 2225/682; A63B 2071/086

(57) ABSTRACT

Mouthguard systems for dispensing a substance (e.g., dietary, nutritional, sports enhancement, herbal, medical prescription, over the counter pharmaceutical, etc.) into a user's mouth are contemplated. Mouthguard systems comprise a container and a mouthguard. Contemplated mouthguards comprise a housing sized and dimensioned to receive the container. Thus, users wearing contemplated mouthguards can have immediate access to a container filled with a desired substance in any setting (e.g., sports, medical, military, etc.).

This application claims priority to U.S. Provisional Application Ser. No. 63/050,547, titled, “Hydrating Mouthguard,” and filed Jul. 10, 2020. All extrinsic materials identified herein are incorporated by reference in their entirety.

### FIELD OF THE INVENTION

The field of the invention is mouthguards that dispense a substance (e.g., water, supplements, electrolytes, etc.) to a user.

### BACKGROUND

The background description includes information that may be useful in understanding the present invention. It is not an admission that any of the information provided herein is prior art or relevant to the presently claimed invention, or that any publication specifically or implicitly referenced is prior art.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

The performance of athletes in sports depends on many factors. Among those factors, properly consuming water and other supplements is often critical to an athlete. Inadequate consumption of water and other supplements can cause an athlete to have a subpar performance during a game, a competition, or a workout. Accessibility to water and other supplements can be difficult in certain sports, such as football, soccer, or basketball, where athletes typically do not carry water and other supplements on them during games, competitions, or workouts. In such circumstances, athletes typically wait for a timeout or a break in the game, the competition, or the workout to access water and other supplements needed.

Some have contemplated devices that are more accessible to an athlete or other individual for hydration. For example, U.S. Pat. No. 9,687,722 (Kennedy), U.S. Pat. No. 9,770,643 (Hawkins), U.S. Patent Publication No. 2014/0166024 (Davidson et al.), U.S. Patent Publication No. 2016/0256762 (Tucker), and U.S. Patent Publication No. 2018/0071611 (Durbin) disclose a mouthguard device that can be used to dispense a substance. Although advances have been made in the field of mouthguard devices, there is still a need for further improvements in such field.

### SUMMARY OF THE INVENTION

The inventive subject matter provides apparatus, systems, and methods in which a user can have immediate access to a substance (e.g., dietary, nutritional, sports enhancement, herbal, medical prescription, over the counter pharmaceutical, etc.) using a mouthguard fluidly coupled to a container filled with the substance. A contemplated mouthguard system comprises a mouthguard and a container configured to hold a substance. The mouthguard comprises a mouthpiece, a housing sized and dimensioned to receive the container, a channel that extends through the mouthguard and into the housing, and an inlet disposed on a first end of the channel. The inlet is positioned within the housing to thereby (i) insert into the container when the container is received by the housing and (ii) fluidly couple the mouthguard to the container. Once fluidly coupled, a user wearing the mouthguard can press against the housing to compress the container and dispense the substance into the user's mouth.

In some embodiments, the container comprises a seal through which the inlet can be inserted to fluidly couple the mouthguard to the container. The seal can be a resealable seal. In such embodiments, the container can be refilled or filled with a new substance, and used multiple times.

The mouthguard can comprise a valve disposed within or on a second end of the channel. The valve prevents or reduces leakage of the substance to the user. For example, the valve can be a duckbill valve that opens when a user compresses the container to dispense the substance.

The housing can comprise a strap connected to a cover. The cover can have a recessed area that is sized and dimensioned to receive a portion of the container. The cover can couple another portion of the housing to close the housing and store container. It is contemplated that the cover is flexible such that a user can push against the cover to compress the container housed within the housing. In other embodiments, it is contemplated that the cover is rigid such that a user can push against the rigid cover to compress the container housed within the housing. It should be appreciated that the housing is positioned outside of the user's mouth, which eliminates size restrictions associated with storing a container or a substance within a portion of the mouthguard that rests inside a user's mouth. Thus, contemplated mouthguard systems allow use of larger containers filled with substances to be immediately accessible to a user.

The mouthguard can further comprise an air channel that extends through the mouthpiece. It is contemplated that the air channel has a first opening on the mouthpiece and a second opening in front of the mouthpiece. When the mouthguard is worn, the mouthpiece is inside a user's mouth. The second opening in front of the mouthpiece is disposed outside the user's mouth. Thus, the user can experience better breathing because the mouthguard allows air travel through the air channel to the outside environment.

In another aspect, a mouthguard configured to hold a container while the mouthguard is worn by the user is contemplated. The mouthguard comprises a mouthpiece and a housing. The housing is sized and dimensioned to receive the container. Furthermore, the housing is coupled to a front of the mouthpiece such that the housing is positioned outside the user's mouth while the mouthguard is worn. As discussed above, a housing positioned outside of the user's mouth allows for larger containers filled with substances (e.g., dietary, nutritional, sports enhancement, herbal, etc.) to be immediately accessible to the user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a front perspective view of an embodiment of mouthguard system.

FIG. 2 is a rear perspective view of the mouthguard system in FIG. 1.

FIG. 3 is a front perspective view of the mouthguard system in FIG. 1 showing the cover removed.

FIG. 4 is an exploded view of the mouthguard system in FIG. 1.

FIG. 5 is a rear perspective view of the mouthguard of the mouthguard system in FIG. 1.

FIG. 6 is a top view of the mouthguard in FIG. 5.

FIG. 7 is a rear view of the mouthguard in FIG. 5.

FIG. 8 is a side view of the mouthguard in FIG. 5.

FIG. 9 is a rear perspective view the container in the mouthguard system in FIG. 1.

FIG. 10 is a top view of the container in FIG. 9.

FIG. 11 is a rear view of the container in FIG. 9.

FIG. 12 is a side view of the container in FIG. 9.

FIG. 13 is a front perspective view of an embodiment of a mouthguard system.

FIG. 14 is a rear perspective view of the mouthguard system in FIG. 13.

FIG. 15 is another front perspective view of the mouthguard system in FIG. 13 showing the cover removed.

FIG. 16 is a front view of the mouthguard system in FIG. 13 showing the cover removed.

FIG. 17 is top view of the mouthguard system in FIG. 13 showing the cover removed.

FIG. 18A is another top view of the mouthguard system in FIG. 13.

FIG. 18B is a cross-sectional view along the line A-A in FIG. 18A of the mouthguard system in FIG. 13.

FIG. 18C is another cross-sectional view along the line A-A in FIG. 18A of the mouthguard system in FIG. 13.

FIG. 19A is a side view of the mouthguard system in FIG. 13.

FIG. 19B is a cross-section view along the line B-B in FIG. 19A of the mouthguard system in FIG. 13.

FIG. 20 is an exploded view of the mouthguard system in FIG. 13.

FIG. 21 is a front perspective view of the container of the mouthguard system in FIG. 13.

FIG. 22 is a rear perspective view of the container in FIG. 21.

FIG. 23 is an exploded view of the mouthguard system in FIG. 13 showing a container that is pierced and omitting the cover.

FIG. 24 is another exploded view of the mouthguard system in FIG. 13 showing a container that is pierced and omitting the cover.

FIG. 25A is a front perspective view of a container.

FIG. 25B is a rear perspective view of the container in FIG. 25A.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

One should appreciate that the disclosed subject matter provides many advantageous technical effects including providing immediate access to a larger container filled with a substance (e.g., dietary, nutritional, sports enhancement, herbal, medical prescription, over the counter pharmaceutical, etc.) for use by athletes and other individuals during a game, a competition, a workout, or any other event. This is especially beneficial when access to larger sources of the substance (e.g., a cooler full of water or a sports enhancement beverage on a sideline) is limited. It should be appreciated that the disclosed subject matter does not depend on sizing a container filled with a substance to fit comfortably within a user's mouth. Contemplated mouthguard systems comprise a mouthguard that has a housing positioned outside a user's mouth when the mouthguard is worn by the user. A user can dispense a substance from a container within the housing by simply pressing against the housing to compress the container and dispense the substance to the user via a channel that extends through the mouthguard.

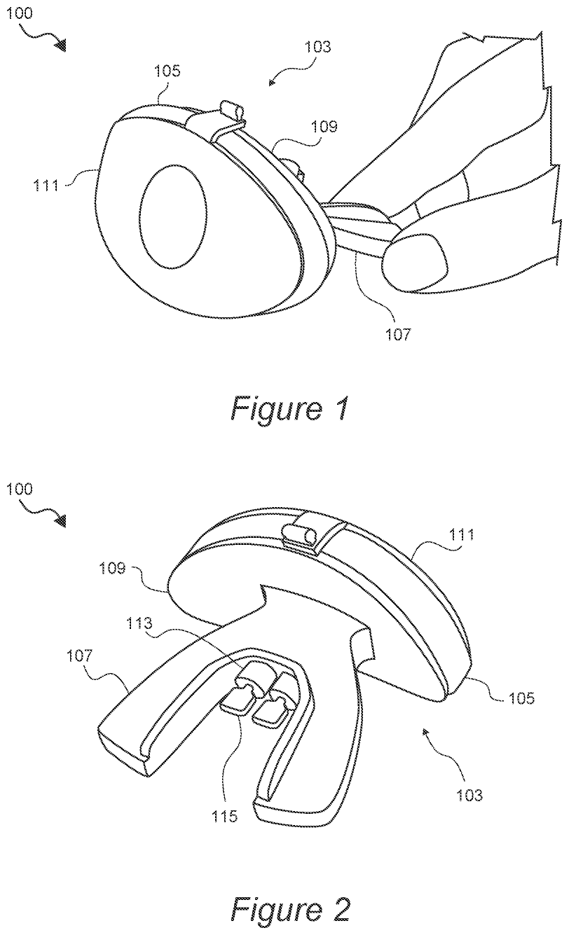

FIGS. 1-4 show various views of an embodiment of a mouthguard system 100. Mouthguard system 100 comprises a mouthguard 103 and a container 105. As shown in FIG. 1, mouthguard 103 comprises a housing 109 sized and dimensioned to receive and hold container 105. It is contemplated that container 105 comprises one or more of a dietary substance, a nutritional substance, a sports enhancement substance, an herbal substance, a medical prescription substance, and an over the counter pharmaceutical substance for a user to consume when desired. Furthermore, mouthguard 103 comprises a mouthpiece 107 sized and dimensioned to fit within a user's mouth. A user can wear mouthguard system 100 by placing mouthpiece 107 inside the user's mouth for mouthpiece 107 to be held by top and/or bottom teeth of the user. Container 105 is held outside the user's mouth in housing 109, which is disposed in front of mouthpiece 107.

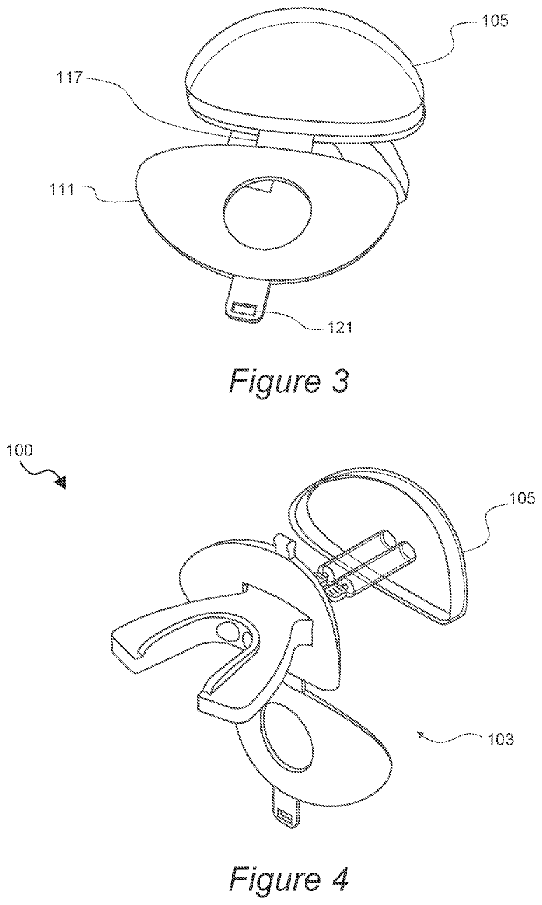

Housing 109 comprises a strap 117 connected to a cover 111 as shown in FIG. 3. It is contemplated that strap 117 is flexible to allow cover 111 to rotate with respect to a rear wall of housing 109 on which container 105 rests when within housing 109. It should be appreciated that the rear wall of housing 109 can be a lip guard to protect the upper and lower lips of a user.

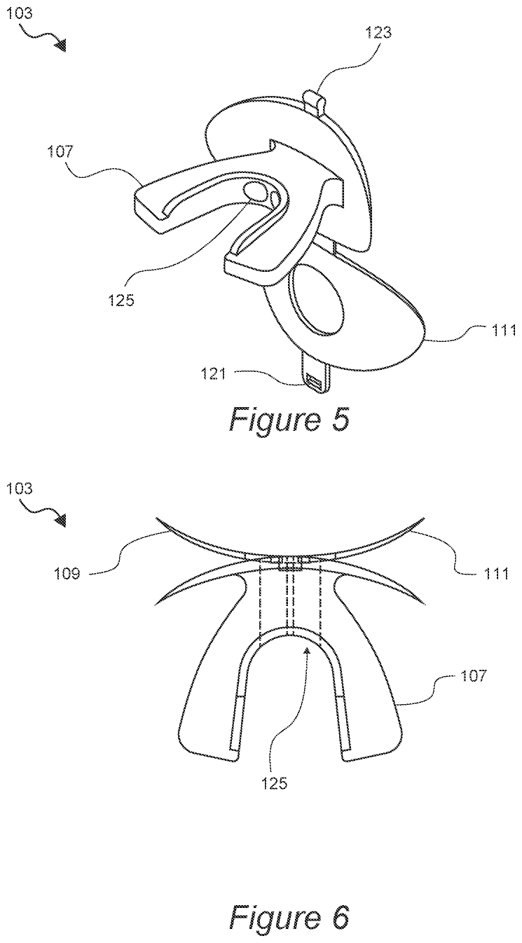

Housing 109 comprises a first coupler 123 configured to couple with a second coupler 121 disposed on cover 111 as shown in FIG. 5. First coupler 123 can be a projection and second coupler 121 can be a slot sized and dimensioned to receive the projection. It is contemplated that first coupler 123 and second coupler 121 can be male-female connectors (e.g., projection and slot), magnetic connectors (e.g., first and second magnets), or hook and loop connectors. Thus, cover 111 can open or close housing 109 via first coupler 123 and second coupler 121 to remove (see, e.g., FIG. 4 showing container 105 out of mouthguard 103) or install and hold container 105 within housing 109 while mouthguard system 100 is used.

In some embodiments, cover 111 is flexible such that a user can press against cover 111, which temporarily deforms, to compress container 105 to dispense a substance. In other embodiments, cover 111 is rigid such that a user can press against cover 111, which substantially holds its form, to compress container 105 to dispense a substance. Whether flexible or rigid, it is contemplated that cover 111 can be pushed towards mouthpiece 107 to compress container 105 and dispense a substance (e.g., dietary, nutritional, sports enhancement, herbal, medical prescription, over the counter pharmaceutical, etc.) to the user wearing mouthguard system 100.

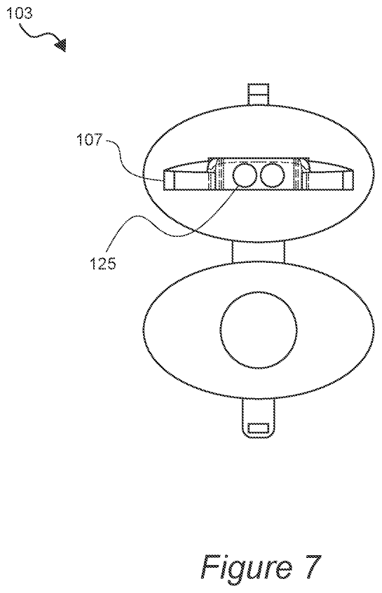

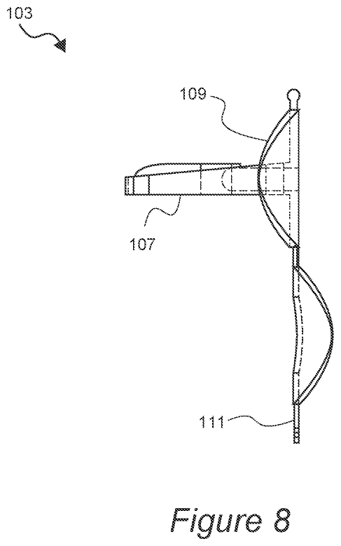

Container 105 can comprise a tube 113 having a removable tab 115 that a user can twist and/or pull to create an opening to dispense a substance from container 105. It is contemplated mouthguard 103 comprises an aperture 125 as shown in FIGS. 6-8 that extends through mouthpiece 107 and into housing 109. As shown in FIG. 2, tube 113 can extend through aperture 125. Thus, as container 105 is compressed, a substance inside the container can flow through the opening created after removable tab 115 is removed into a user's mouth. Additionally, or alternatively, a user can bite down and/or suck on mouthpiece 107 to dispense supplements from within container 105.

Mouthguard 103 can comprise one or more apertures 125 (see FIG. 6) that are dimensioned to receive one or more tubes 113 of container 105 (see FIG. 4). It should be appreciated that such apertures 125 can be any shape that corresponds to the cross-sectional shape of tube 113 that extends such apertures 125.

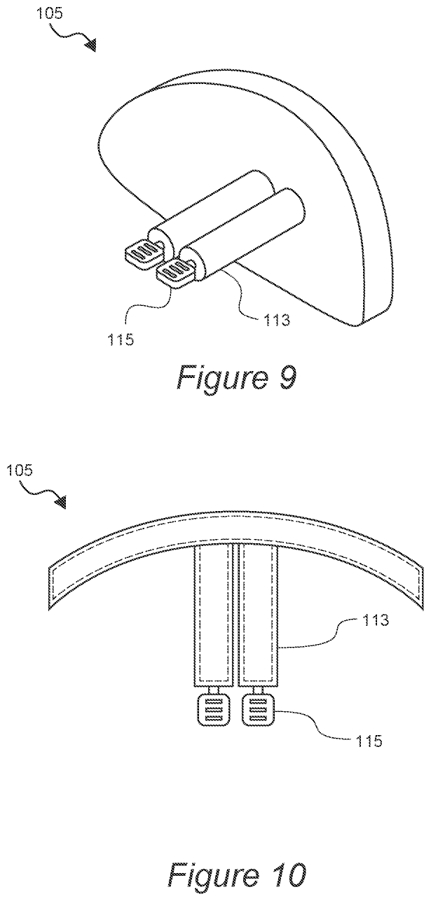

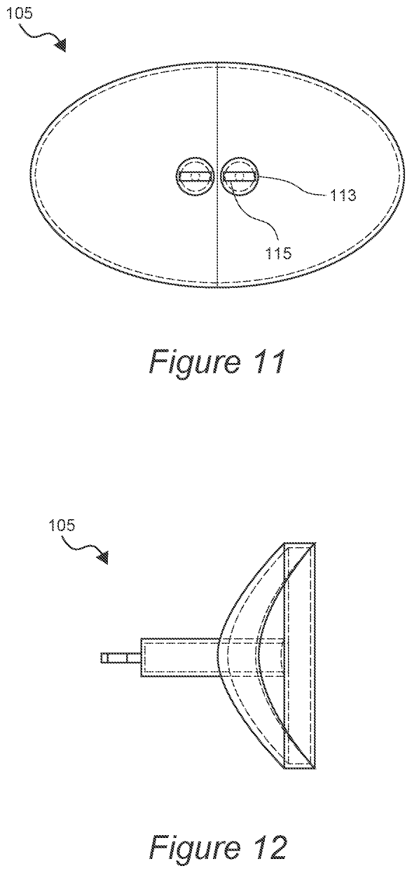

FIGS. 9-12 show various views of container 105 used to carry substances (e.g., dietary, nutritional, sports enhancement, herbal, medical prescription, over the counter pharmaceutical, etc.). Container 105 can be a gel pack containing substances. In such embodiment, the gel pack can be single-use or refillable. The gel pack can be compressed within housing 109 of mouthguard 103 to dispense substances through tube 113 and an opening created after removable tab 115 is removed.

Container 105 is compressible to allow substances to be dispensed. In some embodiments, container 105 can comprise a one-way valve that can be opened by a user's tongue and/or bite to dispense substances. Container 105 can be single-use or refillable to allow the user to refill substances. If refillable, container 105 can comprise an opening or valve to allow a user to refill the substances. The substances can be liquid, gel, powder, or a dissolvable solid form.

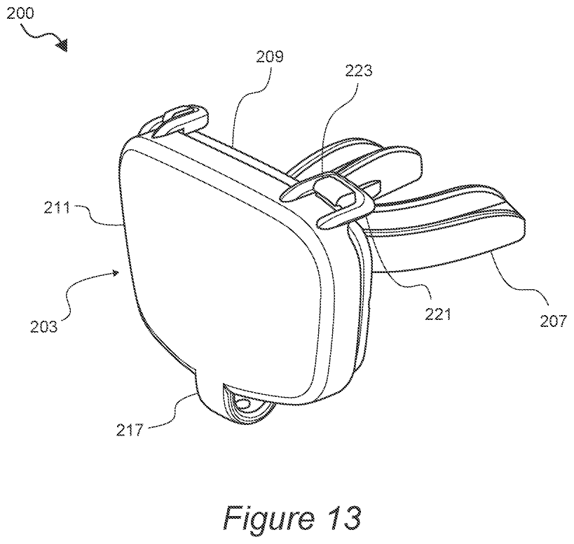

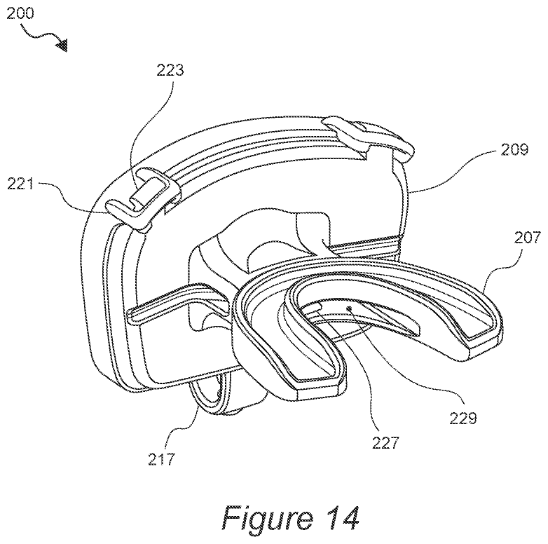

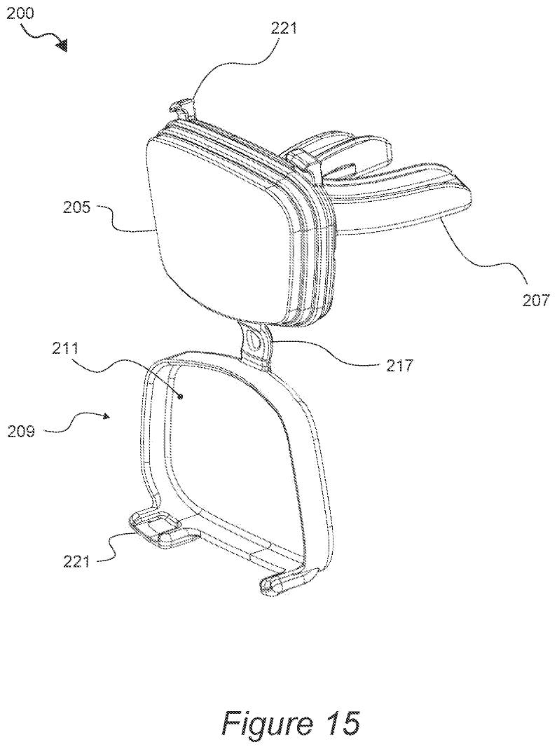

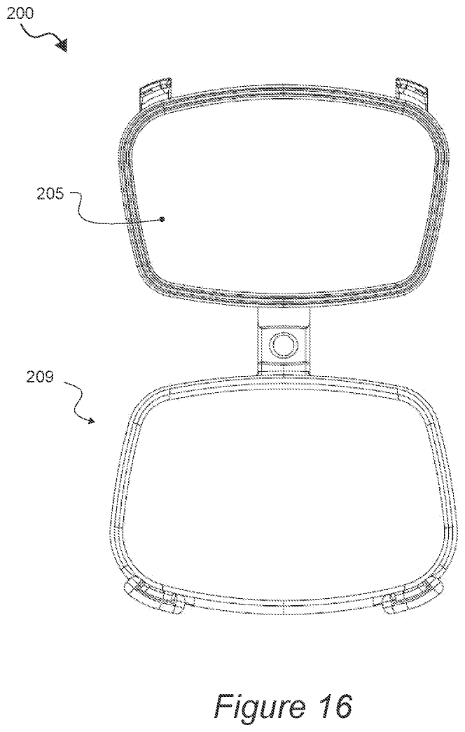

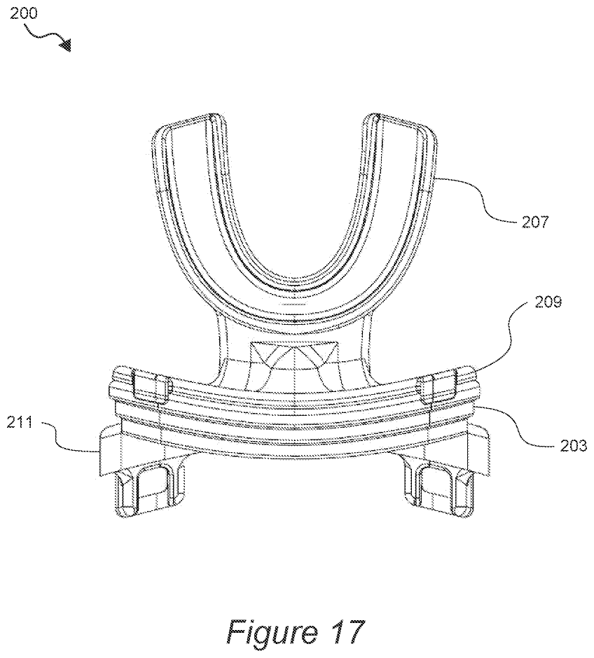

FIGS. 13-17 show various views of an embodiment of a mouthguard system 200 in an opened configuration (FIGS. 15-17) and a closed configuration (FIGS. 13-14). Mouthguard system 200 comprises a mouthguard 203 and a container 205. Mouthguard 203 comprises a housing 209 sized and dimensioned to receive and hold container 205. It is contemplated that container 205 comprises one or more of a dietary substance, a nutritional substance, a sports enhancement substance, an herbal substance, a medical prescription substance, and an over the counter pharmaceutical substance for a user to consume when desired. Furthermore, mouthguard 203 comprises a mouthpiece 207 sized and dimensioned to fit within a user's mouth. A user can wear mouthguard system 200 by placing mouthpiece 207 inside the user's mouth for mouthpiece 207 to be held by top and/or bottom teeth of the user. Container 205 is held outside the user's mouth in housing 209, which is disposed in front of mouthpiece 207.

Housing 209 comprises a strap 217 connected to a cover 211. It is contemplated that strap 217 is flexible to allow cover 211 to rotate with respect to a rear wall of housing 209 on which container 205 rests when within housing 209. It should be appreciated that the rear wall of housing 209 can be a lip guard to protect the upper and lower lips of a user.

Housing 209 comprises a first coupler 223 configured to couple with a second coupler 221 disposed on cover 211. First coupler 223 can be a projection and second coupler 221 can be a slot sized and dimensioned to receive the projection. It is contemplated that first coupler 223 and second coupler 221 can be male-female connectors (e.g., projection and slot), magnetic connectors (e.g., first and second magnets), or hook and loop connectors. Thus, cover 211 can open or close housing 209 via first coupler 223 and second coupler 221 to remove or install and hold container 205 within housing 209 while mouthguard system 200 is used.

In some embodiments, cover 211 is flexible such that a user can press against cover 211, which temporarily deforms, to compress container 205 to dispense a substance. In other embodiments, cover 211 is rigid such that a user can press against cover 211, which substantially holds its form, to compress container 205 to dispense a substance. Whether flexible or rigid, it is contemplated that cover 211 is pushed towards mouthpiece 207 to compress container 205 and dispense a substance (e.g., dietary, nutritional, sports enhancement, herbal, medical prescription, over the counter pharmaceutical, etc.) to the user wearing mouthguard system 200. Mouthguard 203 can further comprise a valve 227 to prevent or reduce unwanted leakage or dispensing of the substance to the user.

Mouthpiece 207 comprises a U-shape for positioning around upper and/or lower teeth of a user. As shown in FIG. 14, mouthpiece 207 is disposed behind a rear wall of housing 209. As noted above, it is contemplated that the rear wall of housing 209 is a lip protector.

An air channel 229 can extend through mouthpiece 207 to improve the ability for a user to breathe while wearing mouthguard system 200. It is contemplated that mouthguard 203 can comprise one or more air channels 229. Air channel 229 comprises an opening disposed in front of mouthpiece 207 such that the opening is outside the user's mouth while mouthguard system 200 is worn.

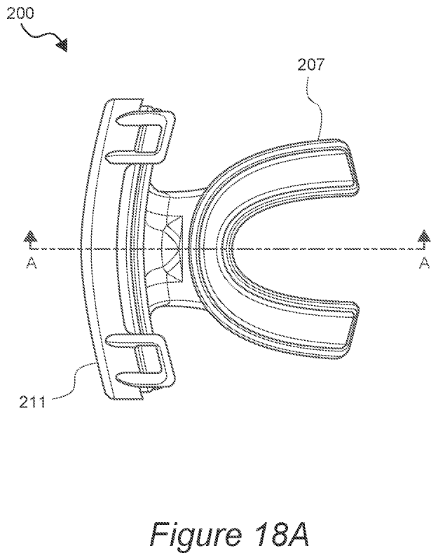

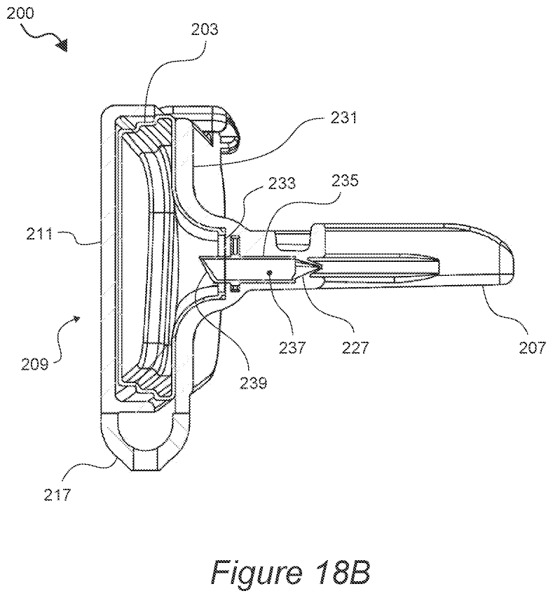

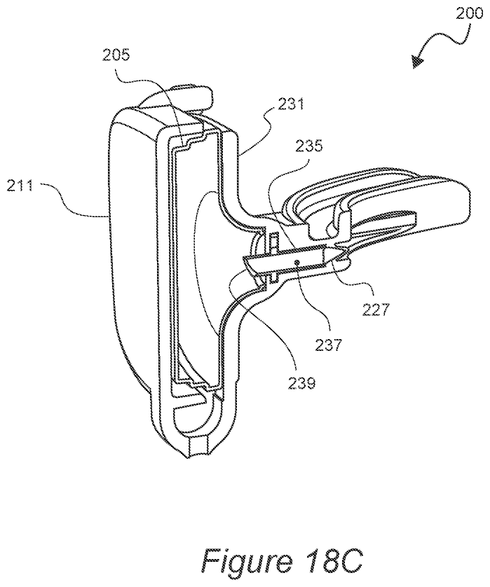

FIG. 18B shows a cross-section of mouthguard system 200 along the line A-A shown in FIG. 18A. As shown in FIG. 18B, container 205 is held within housing 209 of mouthguard 203. Container 205 is fluidly coupled with mouthguard 203 to dispense a substance to a user. Mouthguard 203 comprises a channel 235 that extends through mouthpiece 207 and into housing 209. An inlet 239 is disposed on a first end of channel 235 and within container 205. It is contemplated that inlet 239 can comprise an angled end to facilitate insertion into container as shown in FIG. 18C.

Inlet 239 can be an angled end of a tube 237 disposed in channel 235 as shown in FIGS. 18B-18C. Inlet 239 can be pushed through a seal 233 of container 205 to fluidly couple container 205 and mouthguard 203. It is contemplated inlet 239 can puncture seal 233 of container 205 when container 205 is pressed against the rear wall of housing 209. Container 205 can be pressed against the rear wall of housing 209 by (1) pushing container 205 directly onto the rear wall, (2) placing container 205 proximal to the rear wall and then rotating cover 211 to press container 205 against the rear wall, or (3) placing container 205 on a recessed area of cover 211 and rotating cover 211 to press container 205 against the rear wall. A substance within container 205 can then be delivered to the user by pushing cover 211 towards mouthpiece 207 to thereby compress container 205 and create a flow of the substance through channel 235 and into a user's mouth.

It is contemplated that tube 237 is manufactured as separate component from mouthguard 203 (i.e., they are two separate pieces). Alternatively, tube 237 or inlet 239 can be part of the mold that forms mouthguard 203 (i.e., (1) tube 237 and/or inlet 239 and (2) mouthguard 203 are manufactured together as a single, unitary component).

Leaking or accidental dispensing of the substance from container 205 to the user can be prevented or reduced using a valve. It is contemplated that valve 227 is disposed on a second end of channel 235 to prevent unwanted dispensing or leakage of substance to the user. In other embodiments, a valve can be disposed within tube 237. Valve 227 can (1) open while a user is pushing on cover 211 to compress container 205 and dispense a substance, and (2) close when the user stops pushing on cover 211 to compress container 205. It is contemplated that valve 227 is a duckbill valve. Additionally, the duckbill valve can be part of the mold that forms mouthguard 203 (i.e., the duckbill valve and mouthguard 203 are manufactured together as a single, unitary component). It is contemplated that other one-way valves can be used and/or the valve is manufactured as separate component from mouthguard 203 that is installed into mouthguard 203.

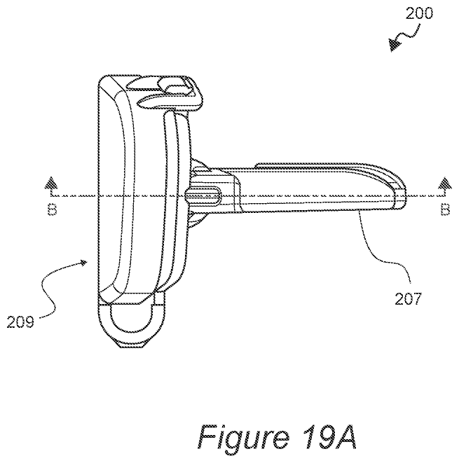

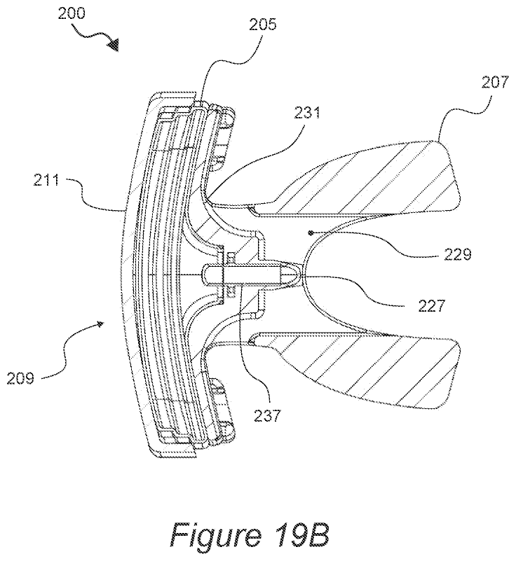

FIG. 19B shows a cross-section of mouthguard system 200 along the line B-B shown in FIG. 19A. From this cross-sectional viewpoint, air channel 229 is shown extending through mouthpiece 207. An opening to air channel 229 is disposed in front of mouthpiece 207 and adjacent to a rear wall 231 of housing 209. This opening is outside of a user's mouth while mouthguard system 200 is worn. As discussed above, it is contemplated that air channel 229 provides improved breathing due to an opening to the outside environment.

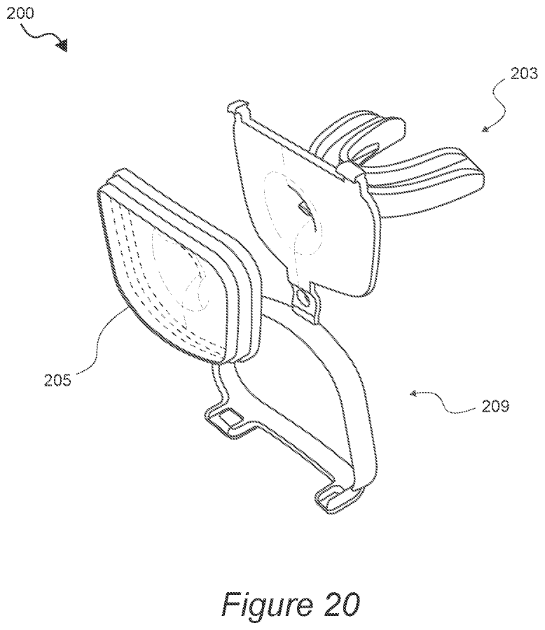

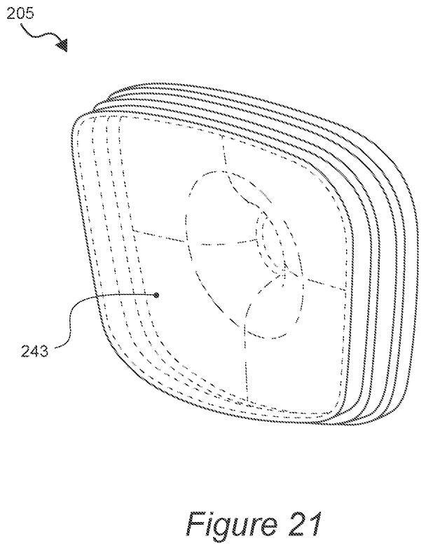

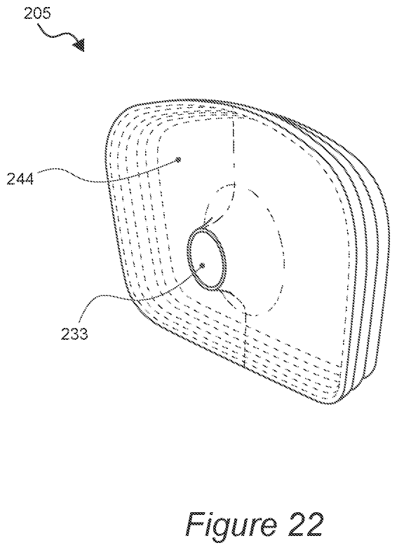

Container 205 can be removed from housing 209 of mouthguard 203 as shown in FIG. 20. FIGS. 21-22 shows various views of container 205. A front surface 243 of container 205 is curved as shown in FIG. 21. It is contemplated that front surface 243 has a curvature to match the curvature a surface of cover 211 of housing 209 which abuts front surface 243 (e.g., FIG. 19B). However, it is contemplated that front surface 243 could be flat, have a concave curvature or have another surface topography.

A rear surface 244 of the container has a concave curve with an elevated portion that has a seal as shown in FIG. 22. It is contemplated that the curvature of rear surface 244 of container 205 matches the curvature of rear wall 231 of housing 209 (e.g., FIG. 19B). However, it is contemplated that rear surface 244 could be flat, have a convex curvature, or have another surface topography.

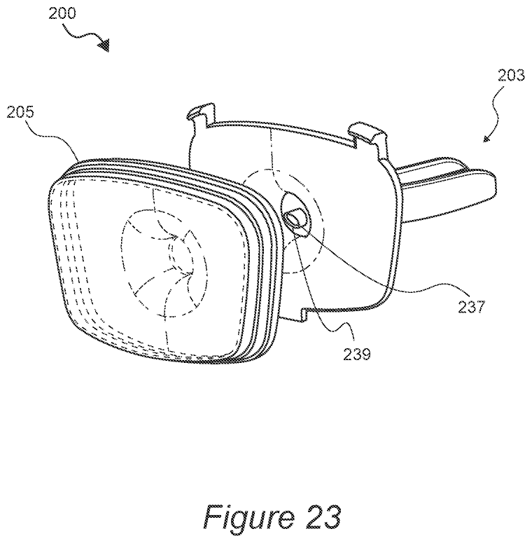

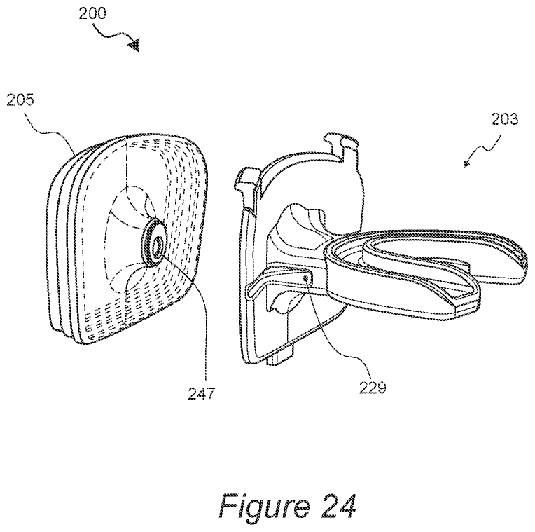

Rear surface 244 can further comprise seal 233 to keep a substance within container 205. It is contemplated that seal 233 is a sticker that can be removed by peeling. Additionally, or alternatively, seal 233 can be punctured by inlet 239 of mouthguard 203 as shown in FIGS. 23-24. It is contemplated that an aperture 247 is created after seal 233 is punctured to allow dispensing of the substance.

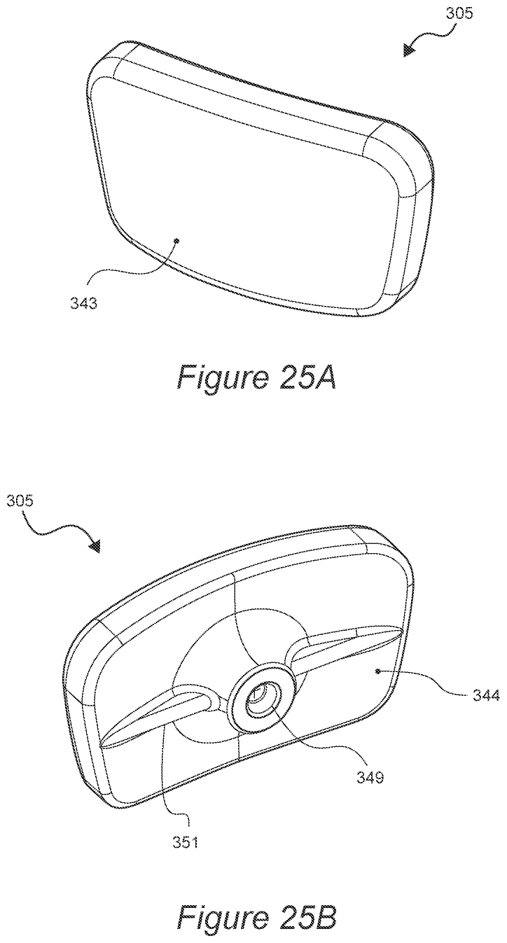

It is contemplated that the container can have a resealable opening to allow multiple uses of the container. FIGS. 25A-25B show a container 305 comprising a front surface 343 and a rear surface 344. Rear surface 344 can comprise a resealable opening 349. It is contemplated that inlet 239 of mouthguard 203 can be inserted through resealable opening 349 of container 305 to fluidly couple container 305 and mouthguard 203. Container 305 can be compressed to thereby dispense a substance to a user. It is contemplated that container 305 comprises one or more of a dietary substance, a nutritional substance, a sports enhancement substance, an herbal substance, a medical prescription substance, and an over the counter pharmaceutical substance for a user to consume when desired.

Container 305 can be refilled or filled with a new substance (e.g., dietary, nutritional, sports enhancement, herbal, medical prescription, over the counter pharmaceutical, etc.) through resealable opening 349. A nozzle or other outlet to a source of a substance can be inserted through resealable opening 349 to thereby fill container 305 with the substance. Thus, a user can reuse container 305 as needed for use with mouthguard 203. Additionally, it is contemplated that container 305 comprises an elevated surface 351 that is sized and dimensioned to fit within a depressed surface of a housing of a mouthguard to aid in the installation of container 305.

It is contemplated that the various mouthguard systems described above can have mouthguards and containers that are sized depending on a user's age and/or size. For example, the container can have a height of 2 inches and a width 3 inches, and the housing can have similar dimensions to receive the container. Furthermore, it is contemplated that the mouthpieces described above can be stock (e.g., standard sizes that are not specifically adapted to a user's mouth), mouth-formed (e.g., designed to be placed in hot water, cooled, and bit by a user to thereby adapt to the user's mouth), or custom-made (e.g., fabricated in a dental office or laboratory from a user's impressions).

Additionally, or alternatively, it is contemplated that the mouthguard can couple with a hydration system (e.g., CamelBak hydration packs, Osprey hydrations packs, etc.). For example, it is contemplated that the tube of the mouthguard can be removed to allow an end of a tube from a hydration pack to be inserted into the mouthguard. In another example, the bite valve or other valve of the hydration pack could be removed, and the tube of the hydration pack can then be connected with the tube of the mouthguard to provide a fluid connection between the hydration pack and the mouthguard.

It should be noted that the mouthguard systems discussed above can be effectively used by individuals in sports, medical, and/or military settings. It is contemplated that the substances within the container can vary depending on the setting. For example, the substance within the container can be nutritional and/or sports enhancement in a sports setting, and dietary, medicinal, nutritional, and/or herbal in a medical or military setting.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A mouthguard configured to hold a container while the mouthguard is worn by the user, the mouthguard comprising:
a mouthpiece sized and dimensioned to fit within the user's mouth;
a housing sized and dimensioned to receive the container; and
wherein the housing is coupled to a front of the mouthpiece such that the housing is positioned outside the user's mouth while the mouthguard is worn by the user.

2. The mouthguard of claim 1, further comprising a channel that extends through the mouthpiece and into the housing.

3. The mouthguard of claim 2, further comprising a tube disposed within the channel.

4. The mouthguard of claim 3, wherein the tube comprises an angled end disposed within the housing.

5. The mouthguard of claim 1, further comprising a valve disposed within or on an end of the channel.

6. The mouthguard of claim 1, wherein the housing comprises a strap connected to a cover.

7. The mouthguard of claim 6, wherein the cover is flexible.

8. The mouthguard of claim 6, wherein the housing comprises a first coupler disposed on the cover that is configured to couple with a second coupler.

9. The mouthguard of claim 7, wherein the first coupler is a slot and the second coupler is a projection.

10. The mouthguard of claim 1, further comprising an air channel that extends through the mouthpiece.

11. The mouthguard of claim 10, further comprising an opening to the air channel that is disposed at the front of the mouthpiece such that the opening is outside the user's mouth while the mouthguard is worn.

12. A mouthguard system for dispensing a substance into a user's mouth, the mouthguard system comprising:
a container configured to hold the substance;
a mouthguard comprising:
a mouthpiece;
a housing sized and dimensioned to receive the container;
a channel that extends through the mouthpiece and into the housing an inlet disposed on a first end of the channel; and
wherein the inlet is positioned within the housing to thereby (i) insert into the container when the container is received by the housing and (ii) fluidly couple the mouthguard to the container.

13. The mouthguard system of claim 12, wherein the container is compressible.

14. The mouthguard system of claim 12, wherein the container comprises a resealable opening.

15. The mouthguard system of claim 12, wherein the mouthguard comprises a valve disposed within or on a second end of the channel.

16. The mouthguard system of claim 12, wherein the housing comprises a strap connected to a cover.

17. The mouthguard system of claim 16, wherein the cover is flexible.

18. The mouthguard system of claim 16, wherein the housing comprises a first coupler disposed on the cover that is configured to couple with a second coupler.

19. The mouthguard system of claim 12, further comprising an air channel that extends through the mouthpiece.

20. The mouthguard system of claim 12, wherein the housing is disposed in front of the mouthpiece such that that the housing is positioned outside the user's mouth while the mouthguard is worn.
